(19) United States
(12) Patent Application Publication
(10) Pub. No.: US 2022/0136593 A1
(43) Pub. Date: May 5, 2022

(54) FRICTION ENGAGING DEVICE

(71) Applicants: JATCO Ltd, Fuji-shi, Shizuoka (JP); NISSAN MOTOR CO., LTD., Yokohama-shi, Kanagawa (JP)

(72) Inventor: Yasuhiro ISHIKAWA, Fuji-shi, Shizuoka (JP)

(73) Assignees: JATCO Ltd, Fuji-shi, Shizuoka (JP); NISSAN MOTOR CO., LTD., Yokohama-shi, Kanagawa (JP)

(21) Appl. No.: 17/427,796

(22) PCT Filed: Nov. 8, 2019
(86) PCT No.: PCT/JP2019/043814

§ 371 Date: Aug. 2, 2021

(30) Foreign Application Priority Data
Feb. 22, 2019 (JP) 2019-030366

(51) Int. Cl. F16H 45/02; F16D 13/52

(52) U.S. Cl. CPC F16H 45/02; F16H 2045/0284; F16D 13/52

(57) ABSTRACT

A friction engaging device includes a plurality of first plates slidably fitted to an outer periphery side cylindrical member, a plurality of second plates slidably fitted to an inner periphery side cylindrical member, a piston pushing the first plates and the second plates by moving in an axial direction, a biasing member applying a bias force to the piston in the axial direction, and a plate member supporting a first end of the biasing member. The plate member slides in the axial direction in a state where the plate member is fitted to either one of the outer periphery side cylindrical member and the inner periphery side cylindrical member.

### TECHNICAL FIELD

The present invention relates to a friction engaging device.

### BACKGROUND ART

In Patent Literature 1, a piston is directly fitted to a hub member of a lock-up clutch to form an anti-rotation structure for preventing the relative rotation between the piston and one of the members of the lock-up clutch.

FIG. 4 is a view for explaining a lock-up clutch 100 according to a conventional example. (a) is a view for explaining a part around a piston 200 of the lock-up clutch 100. (b) is a perspective view of the piston 200.

As illustrated in (a) and (b) of FIG. 4, the piston 200 includes a ring-shaped base 210, a pushing portion 220 provided on the outer periphery side of the base 210, and a ring-shaped protrusion 250 protruding in the direction of a center axis (the direction of a rotation axis X) from the base 210 on the inner diameter side of the pushing portion 220.

Splines Sp are formed on the outer periphery surface of the protrusion 250. The protrusion 250 is spline-fitted to the inner periphery of a clutch hub 300 of the lock-up clutch 100. This prevents the relative rotation between the piston 200 and the clutch hub 300.

In the piston 200, the protrusion 250 and the base 210 are formed integrally. Therefore, the shape of the piston 200 inevitably becomes complicated shape and thus its shape cannot be selected freely.

Accordingly, it is required to secure the degree of freedom in selecting the shape of the piston.

### PRIOR ART DOCUMENT

### Patent Document

Patent Document 1: JP 2014-74438A

### SUMMARY OF INVENTION

The present invention relates to a friction engaging device including:

a plurality of first plates slidably fitted to an outer periphery side cylindrical member,

a plurality of second plates slidably fitted to an inner periphery side cylindrical member,

a piston pushing the first plates and the second plates by moving in an axial direction,

a biasing member applying a bias force to the piston in the axial direction, and

a plate supporting a first end of the biasing member, wherein

the plate is slidably fitted to either one of the outer periphery side cylindrical member and the inner periphery side cylindrical member in the in the axial direction.

According to the present invention, it is possible to secure the degree of freedom in selecting the shape of the piston.

### BRIEF DESCRIPTION OF DRAWINGS

FIG. 1 is a view for explaining a lock-up device.

FIG. 2 is a view for explaining a lock-up clutch.

FIG. 3 is a view for explaining a part around a piston.

FIG. 4 is a view for explaining a piston according to a conventional example.

### DESCRIPTION OF EMBODIMENTS

Hereinafter, a case where a friction engaging device of the present invention is a lock-up clutch 4 included in a torque converter 1 will be described as an example.

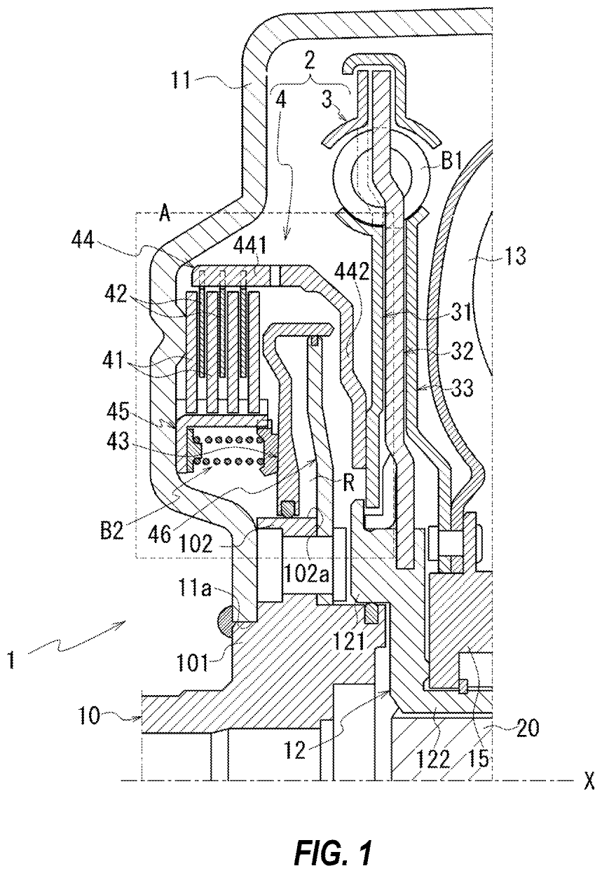

FIG. 1 is a view for explaining a lock-up device 2.

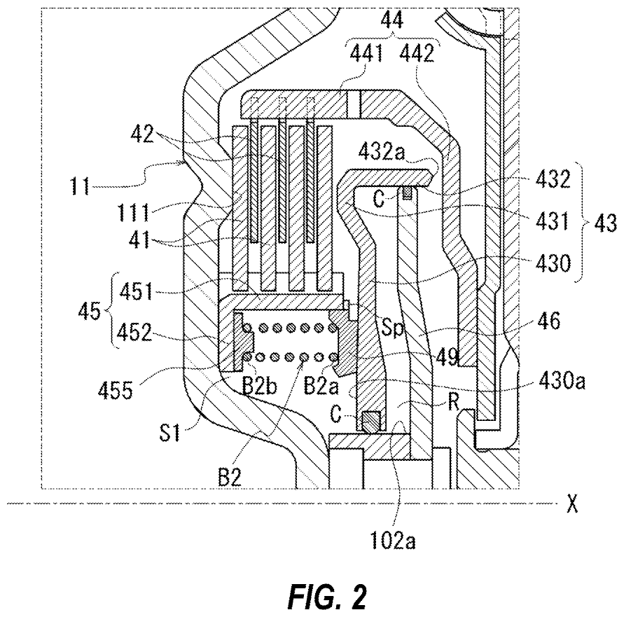

FIG. 2 is a view for explaining a part around the lock-up clutch 4 and is an enlarged view of the region A in FIG. 1.

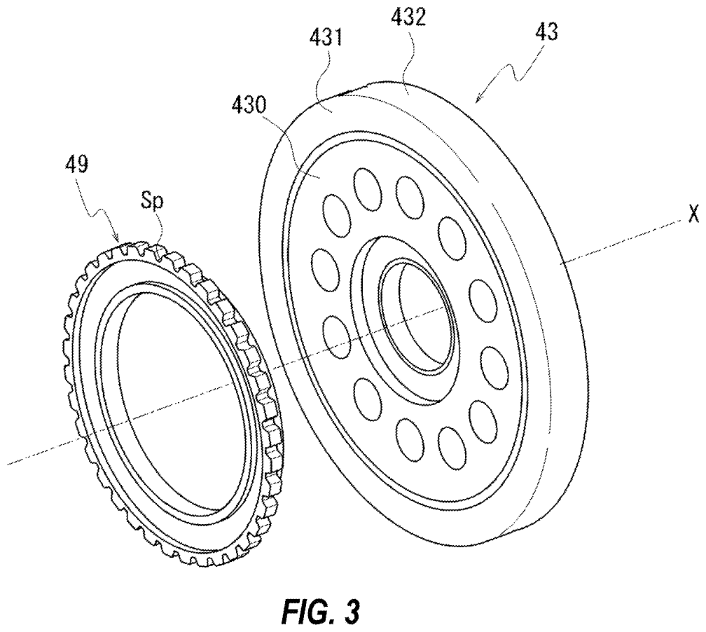

FIG. 3 is a view for explaining a part around a piston 43 and is an exploded perspective view of the piston 43 viewed from the left side of FIG. 1.

As illustrated in FIG. 1, the lock-up device 2 is provided inside a front cover 11 of the torque converter 1. The lock-up device 2 includes a damper device 3 and the lock-up clutch 4.

A rotational driving force of a driving source (not shown) is transmitted to the front cover 11 of the torque converter 1 via a circular plate not shown.

In the damper device 3, when the lock-up device 2 enters a lock-up state, the rotational driving force transmitted to the front cover 11 is input to a drive plate 31 of the damper device 3 via the lock-up clutch 4.

The damper device 3 further includes a driven plate 32 and a side plate 33, in addition to the drive plate 31.

The drive plate 31 and the driven plate 32 are relatively rotatably provided on a common rotation axis X. The drive plate 31 and the driven plate 32 are connected to each other via a spring B1 provided along the circumferential direction around the rotation axis X such that the rotation can be transmitted.

In the damper device 3, the drive plate 31 is provided on one side (front cover 11 side) of the driven plate 32 in the direction of the rotation axis X and the side plate 33 is provided on the other side (turbine runner 13 side).

The side plate 33 is connected to the turbine runner 13 of the torque converter 1.

The inner diameter side of the driven plate 32 is relatively non-rotatably connected to a connecting portion 121 of a turbine hub 12.

The turbine hub 12 includes a cylindrical mating portion 122 on the inner diameter side of the connecting portion 121. The mating portion 122 is spline-fitted to the outer periphery of a rotation transmission shaft 20.

The mating portion 122 extends from the inner diameter side of the connecting portion 121 along the rotation axis X in a direction away from the connecting portion 121 (the right direction in FIG. 1). A support member 15 of the turbine runner 13 is relatively non-rotatably connected to the outer periphery of the mating portion 122.

The inner diameter side of the side plate 33 together with the turbine runner 13 are relatively non-rotatably connected to the support member 15. The driven plate 32 and the side plate 33 are relatively non-rotatably provided on the common rotation axis X via the turbine hub 12 and the support member 15.

The drive plate 31 is integrally rotatably connected to a clutch drum 44 of the lock-up clutch 4 on the front cover 11 side of the driven plate 32 in the direction of the rotation axis X.

The lock-up clutch 4 includes inner diameter side friction plates 41 integrally rotating with the front cover 11, outer diameter side friction plates 42 integrally rotating with the drive plate 31, and a piston 43 pushing the inner diameter side friction plates 41 and the outer diameter side friction plates 42 in the direction of the rotation axis.

The outer diameter side friction plates 42 are spline-fitted to the inner periphery of a peripheral wall 441 of the clutch drum 44. The inner diameter side friction plates 41 are spline-fitted to the outer periphery of a peripheral wall 451 of a clutch hub 45.

The inner diameter side friction plates 41 and the outer diameter side friction plates 42 are alternately arranged in the direction of the rotation axis X.

In the present embodiment, the inner diameter side friction plates 41 and the outer diameter side friction plates 42 are alternately arranged between the inner diameter side friction plates 41, 41 positioned on both sides in the direction of the rotation axis X.

As illustrated in FIG. 2, the clutch drum 44 has a bottomed cylindrical shape including a bottom wall 442 and the peripheral wall 441 surrounding the peripheral edge of the bottom wall 442.

An opening of the peripheral wall 441 of the clutch drum 44 is oriented to the front cover 11 side in a state where the bottom wall 442 is oriented perpendicular to the direction of the rotation axis X.

The inner diameter side of the bottom wall 442 of the clutch drum 44 is connected to the drive plate 31. The clutch drum 44 is relatively non-rotatably connected to the drive plate 31.

The outer diameter side friction plates 42 are spline-fitted to the inner periphery of the peripheral wall 441 of the clutch drum 44 such that the outer diameter side friction plates 42 can move in the direction of the rotation axis X.

As illustrated in FIG. 2, the clutch hub 45 has a bottomed cylindrical shape including a bottom wall 452 and the peripheral wall 451 surrounding the peripheral edge of the bottom wall 452. The bottom wall 452 of the clutch hub 45 is fixed to the front cover 11 in a state where an opening of the peripheral wall 451 is oriented to the bottom wall 442 of the clutch drum 44.

The clutch hub 45 is relatively non-rotatably connected to the front cover 11.

The inner diameter side friction plates 41 are spline-fitted to the outer periphery of the peripheral wall 451 of the clutch hub 45 such that the inner diameter side friction plates 41 can move in the direction of the rotation axis X.

The clutch drum 44 and the clutch hub 45 are coaxially arranged on the common rotation axis X.

The peripheral wall 451 of the clutch hub 45 and the peripheral wall 441 of the clutch drum 44 overlap with each other in the radial direction of the rotation axis X such that, as viewed in the radial direction of the rotation axis X, the peripheral wall 451 and the peripheral wall 441 are superposed with each other.

An abutting portion 111 abutting the inner diameter side friction plate 41 is provided in the front cover 11.

As viewed in the direction of the rotation axis X, the abutting portion 111 faces, from the direction of the rotation axis X, the region where the inner diameter side friction plates 41 and the outer diameter side friction plates 42 overlap with each other.

As viewed from the inner diameter side friction plates 41 and the outer diameter side friction plates 42, the piston 43 is provided on an opposite side of the front cover 11 (the bottom wall 442 side).

As illustrated in FIGS. 2, 3, as viewed from the direction of the rotation axis X, the piston 43 includes a ring-shaped base 430, a cylindrical portion 432 surrounding the entire outer peripheral edge of the base 430. The ring-shaped base 430 is formed with a substantially uniform thickness in the direction of the rotation axis X. A side surface 430a on the front cover 11 side (the left side in the drawing) of the base 430 has a flat surface perpendicular to the direction of the rotation axis X.

As illustrated in FIG. 1, a support member 10 for supporting the piston 43 is provided on the inner diameter side of the front cover 11. The support member 10 is provided though an opening 1 la on the inner diameter side of the front cover 11 in the direction of the rotation axis X. The outer periphery of a mating portion 101 mated within the opening 11 a is welded to the front cover 11.

In the support member 10, a support portion 102 for supporting the piston 43 is provided adjacent to the mating portion 101. The support portion 102 has an outer diameter larger than that of the mating portion 101, and is housed inside the front cover 11.

As illustrated in FIG. 2, the support portion 102 has an outer periphery 102a which is a smooth surface in parallel with the rotation axis X. The base 430 of the piston 43 is externally fitted on the outer periphery of the support portion 102. In this state, the piston 43 is slidably provided on the outer periphery 102a in the direction of the rotation axis X.

The piston 43 externally fitted on the support portion 102 is provided such that the base 430 is oriented perpendicular to the rotation axis X. In this state, the piston 43 is provided such that a center axis of the base 430 is positioned on the rotation axis X.

In the piston 43, a seal ring C is mated with the inner periphery of the base 430 to seal a gap between the inner periphery of the base 430 and the outer periphery 102a of the support portion 102.

As viewed from the direction of the rotation axis X, the base 430 is provided across the region, where the clutch hub 45 is provided, from the inner diameter side to the outer diameter side.

The region on the outer periphery edge side of the base 430 is curved in a direction approaching the inner diameter side friction plates 41 and the outer diameter side friction plates 42 (the left direction in the drawing). The curved region consists a pushing portion 431 for pushing the inner diameter side friction plates 41 in the direction of the rotation axis X.

As viewed from the direction of the rotation axis X, the pushing portion 431 faces the region where the inner diameter side friction plates 41 and the outer diameter side friction plates 42 overlap with each other.

As illustrated in FIG. 2, on the inner diameter side of the peripheral wall 441 of the clutch drum 44, the cylindrical portion 432 surrounding the outer periphery of the base 430 extends in a direction away from the inner diameter side friction plates 41 and the outer diameter side friction plates 42 (the right direction in the drawing).

The cylindrical portion 432 has a tip end 432a facing the bottom wall 442 with a gap therebetween in the direction of the rotation axis X.

A seal ring C provided on the outer periphery of an annular wall 46 elastically contacts the inner periphery of the cylindrical portion 432. The seal ring C is provided to seal a gap between the inner periphery of the cylindrical portion 432 and the outer periphery of the annular wall 46.

The inner periphery of the annular wall 46 is fixed to the support portion 102 of the piston 43.

Therefore, a space surrounded by the piston 43, the annular wall 46, and the support portion 102 is formed on the inner diameter side of the cylindrical portion 432 of the piston 43 (the side of the rotation axis X). The space consists an oil chamber R to which a working hydraulic pressure of the piston 43 is supplied.

The working hydraulic pressure for the piston 43 is supplied to the oil chamber R via an oil passage (not shown) provided in the support member 10.

In the lock-up clutch 4, when the working hydraulic pressure is supplied to the oil chamber R, the piston 43 is displaced to the front cover 11 side (the left side in the drawing) while sliding on the outer periphery 102a of the support portion 102.

Then, the inner diameter side friction plates 41 and the outer diameter side friction plates 42 are relatively non-rotatably engaged with each other between the pushing portion 431 of the piston 43 and the abutting portion 111 of the front cover 11.

This restricts the relative rotation around the rotation axis X between the front cover 11 to which the inner diameter side friction plates 41 are connected via the clutch hub 45 and the drive plate 31 to which the outer diameter side friction plates 42 are connected via the clutch drum 44, whereby the lock-up clutch 4 enters an engaged state.

As illustrated in FIG. 2, in the lock-up clutch 4, a spring B2 is provided on the inner diameter side of the peripheral wall 451 of the clutch hub 45.

The spring B2 has a second end B2b supported by a spring supporting piece 455 fixed to the bottom wall 452 of the clutch hub 45 and a first end B2a supported by a plate member 49 interposed between the first end B2a and the base 430 of the piston 43.

The spring B2 is provided in parallel with the rotation axis X in a state of being compressed in the direction of the rotation axis X.

Therefore, the plate member 49 is pressed against and contact with the side surface 430a of the base 430 of the piston 43 by the bias force acting from the spring B2.

Splines Sp are formed along the direction of the rotation axis X on the outer periphery of the plate member 49. The plate member 49 is spline-fitted to the inner periphery of the peripheral wall 451 of the clutch hub 45. The relative rotation around the rotation axis X between the plate member 49 and the clutch hub 45 is restricted. Further, in this state, the relative displacement between the plate member 49 and the peripheral wall 451 of the clutch hub 45 is permitted in the direction of the rotation axis X.

Therefore, since the plate member 49 relatively displaces with respect to the peripheral wall 451 of the clutch hub 45 in conjunction with the displacement of the piston 43 in the direction of the rotation axis X, the displacement of the piston 43 in the direction of the rotation axis X is not impeded.

The spring B2 is arranged in the space on the inner diameter side of the clutch hub 45 (internal space Si). A plurality of springs B2 are provided in the circumferential direction around the rotation axis X at equal intervals.

The spring B2 biases the piston 43 in a direction in which the piston 43 is displaced to the oil chamber R side (the right side in the drawing).

Therefore, in the lock-up clutch 4, when the supply of the working hydraulic pressure to the oil chamber R is terminated, the piston 43 is displaced to the oil chamber R side by the bias force of the spring B2 acting through the plate member 49.

The displacement of the piston 43 to the oil chamber R side displaces the pushing portion 431 of the piston 43 in a direction away from the inner diameter side friction plates 41 to allow the relative rotation between the inner diameter side friction plates 41 and the outer diameter side friction plates 42.

This allows the relative rotation around the rotation axis X between the front cover 11 to which the inner diameter side friction plates 41 are connected via the clutch hub 45 and the drive plate 31 to which the outer diameter side friction plates 42 are connected via the clutch drum 44, whereby the lock-up clutch 4 enters a disengaged state.

In the present embodiment, the first end B2a of the spring B2 is supported by the plate member 49 while the second end B2b is supported by the spring supporting piece 455, thereby forming an anti-rotation structure for preventing the relative rotation between the spring B2 and the clutch hub 45.

In this state, the plate member 49 and the bottom wall 452 supporting the spring B2 are arranged in the internal space S1 of the clutch hub 45.

Here, a lubricating oil passage (not shown) for supplying an oil OL to the internal space S1 is provided in the support member 10 (see FIG. 1) positioned on the inner diameter side of the internal space S1.

Here, the oil OL discharged from the lubricating oil passage (not shown) to the internal space S1 flows through the internal space S1 (the inner diameter side of the clutch hub 45) from the inner diameter side to the outer diameter side by a centrifugal force due to the rotation of the torque converter 1, and reaches the inner diameter side friction plates 41 and the outer diameter side friction plates 42 through the plate member 49 side.

The lubricating oil passage (not shown) is provided for supplying the oil OL to the inner diameter side friction plates 41 and the outer diameter side friction plates 42 for cooling. The internal space S1 can be regarded as a lubricating passage for supplying the oil OL to be used for cooling to the inner diameter side friction plates 41 and the outer diameter side friction plates 42.

Then, in the lubricating passage, the plate member 49 and the spring supporting piece 455 supporting the spring B2 face each other.

The lock-up clutch 4 (a friction engaging device) according to the present embodiment includes:

(1) the plurality of outer diameter side friction plates 42 (first plates) slidably fitted to the clutch drum 44 (an outer periphery side cylindrical member),

the plurality of inner diameter side friction plates 41 (second plates) slidably fitted to the clutch hub 45 (an inner periphery side cylindrical member),

the piston 43 pushing the outer diameter side friction plates 42 and the inner diameter side friction plates 41 by moving in the direction of the rotation axis X,

the spring B2 (a biasing member) applying the bias force to the piston 43 in the direction of the rotation axis X, and

the plate member 49 supporting the first end B2a of the spring B2.

The plate member 49 is slidably fitted to the clutch hub 45 in the direction of the rotation axis X.

By configuring in this manner, using the plate member 49 which is a member separate from the piston 43, the anti-rotation structure of the spring B2 for preventing the relative rotation between the spring B2 and the clutch hub 45 can be formed.

This can secure the degree of freedom in selecting the shape of the piston 43. For example, the piston is no longer required to have an anti-rotation structure, and thus can be made into a simple shape (the ring-shaped base 430), or a shape specialized for satisfying functional requirements other than anti-rotation. Further, since the base 430 of the piston 43 is plate-shaped, the axial length of the entire device can be reduced.

The lock-up clutch 4 (a friction engaging device) according to the present embodiment has a following configuration.

(2) the second end B2b of the spring B2 is supported by the spring supporting piece 455 (a member integrally rotating with the inner periphery side cylindrical member) of the bottom wall 452 of the clutch hub 45.

By configuring in this manner, the first end B2a and the second end B2b of the spring B2 rotate integrally in the circumferential direction around the rotation axis X. Therefore, the spring B2 can be prevented from being twisted by the rotation.

The present embodiment illustrates that the second end B2b of the spring B2 is supported by the spring supporting piece 455 (the inner periphery side cylindrical member itself) of the bottom wall 452 of the clutch hub 45, but the present invention is not limited thereto. For example, the second end B2b of the spring B2 may be supported by the front cover 11 (a separate member integrally rotating with the inner periphery side cylindrical member).

The lock-up clutch 4 (a friction engaging device) according to the present embodiment has a following configuration.

(3) the oil OL that has passed through the space on the plate member 49 side flows to the outer diameter side friction plates 42 and the inner diameter side friction plates 41.

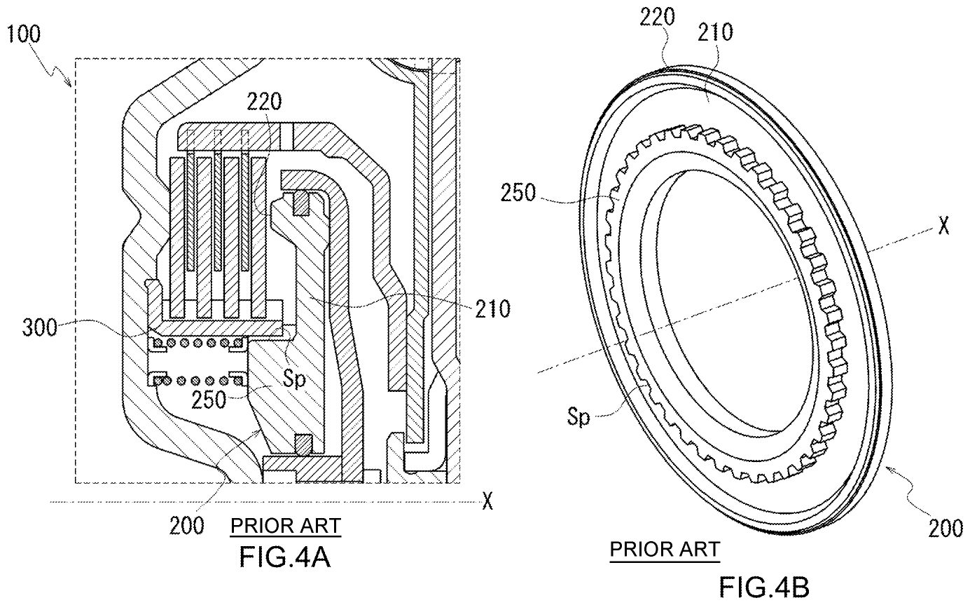

As illustrated in FIG. 4, in the lock-up clutch 100 according to the conventional example, when the piston 200 engages with a friction engaging element member, a portion (protrusion 250) of the piston 200 protruding in the direction of the rotation axis X may prevent the oil OL from flowing from the inner diameter side to the outer diameter side.

With the above-mentioned configuration which separates the plate member 49 from the piston 43, the space though which the oil OL flows is increased and the oil OL is supplied to the lock-up clutch 4 (the outer diameter side friction plates 42 and the inner diameter side friction plates 41) smoothly.

The present embodiment illustrates that the plate member 49 is slidably spline-fitted to the clutch hub 45 in the direction of the rotation axis X and thus the anti-rotation structure of the spring B2 for preventing the relative rotation between the spring B2 and the clutch hub 45 is formed, but the present invention is not limited thereto. For example, the plate member 49 slidably spline-fitted to the clutch drum 44 in the direction of the rotation axis X may form an anti-rotation structure of the spring B2 for preventing the relative rotation between the spring B2 and the clutch drum 44.

In this case, the second end B2b of the spring B2 may be supported by the clutch drum 44 itself, or may be supported by a member integrally rotating with the clutch drum 44.

When the plate member 49 has been spline-fitted to the clutch drum 44, since the coupling part between the piston 43 and the plate member 49 is required to be provided on the outer diameter side, the piston 43 is extended in the radial direction. Then, the lock-up clutch 4 increases in size in the radial direction.

In contrast, when the plate member 49 has been spline-fitted to the clutch hub 45, the space inside the clutch hub 45 can be utilized and the piston 43 is not required to extend in the radial direction. Hence, it is preferable to spline-fit the plate member 49 to the clutch hub 45 since the size of the lock-up clutch 4 is not increased.

The present invention is not limited to the foregoing embodiments, and various changes and modifications which can be made within the spirit and scope of the present invention are included in the present invention.

What is claimed is:

1.-5. (Canceled)

6. A friction engaging device comprising:
a plurality of first plates slidably fitted to an outer periphery side cylindrical member,
a plurality of second plates slidably fitted to an inner periphery side cylindrical member,
a piston pushing the first plates and the second plates by moving in an axial direction,
a biasing member applying a bias force to the piston in the axial direction, and
a plate member supporting a first end of the biasing member, wherein
the plate member slides in the axial direction in a state where the plate member is fitted to either one of the outer periphery side cylindrical member and the inner periphery side cylindrical member.

7. The friction engaging device according to claim 6, wherein
a second end of the biasing member is supported by a member integrally rotating with the either one of the outer periphery side cylindrical member and the inner periphery side cylindrical member.

8. The friction engaging device according to claim 6, wherein
the plate member is fitted to the inner periphery side cylindrical member.

9. The friction engaging device according to claim 6, wherein
an oil that has passed through a space on a side of the plate member flows to the first plates and the second plates.

10. The friction engaging device according to claim 6, wherein
the friction engaging device is a lock-up clutch of a torque converter.
